(19) United States
(12) Patent Application Publication
(10) Pub. No.: US 2025/0028016 A1
(43) Pub. Date: Jan. 23, 2025

(54) LOCALIZATION USING CARRIER PHASE INFORMATION

(71) Applicant: Samsung Electronics Co., Ltd., Suwon-si (KR)

(72) Inventors: Vishnu Vardhan Ratnam, Plano, TX (US); Wei Sun, Allen, TX (US); Bilal Sadiq, Plano, TX (US); Hao Chen, Allen, TX (US); Kyeong Jin Kim, Plano, TX (US); Shunyao Wu, Allen, TX (US); Boon Loong Ng, Plano, TX (US); Jianzhong Zhang, Dallas, TX (US)

(21) Appl. No.: 18/770,486

(22) Filed: Jul. 11, 2024

Related U.S. Application Data
(60) Provisional application No. 63/527,540, filed on Jul. 18, 2023.

(51) Int. Cl. G01S 5/02; G01S 5/04; G01S 5/14

(52) U.S. Cl. CPC G01S 5/0268; G01S 5/0244; G01S 5/04; G01S 5/145

(57) ABSTRACT

A method includes obtaining range estimates and carrier phase estimates from each of multiple anchors. The method also includes, in response to determining that a trilateration technique is to be performed, (i) obtaining improved range estimates using the carrier phase estimates and (ii) determining a first location estimate of a target device using the trilateration technique and the improved range estimates. The method also includes, in response to determining that a triangulation technique is to be performed, (i) obtaining differential range estimates using the carrier phase estimates and (ii) determining a second location estimate of the target device using the triangulation technique and the differential range estimates. The method also includes combining the first location estimate and the second location estimate to determine an overall location estimate of the target device.

### CROSS-REFERENCE TO RELATED APPLICATION AND CLAIM OF PRIORITY

This application claims priority under 35 U.S.C. § 119(e) to U.S. Provisional Patent Application No. 63/527,540, filed on Jul. 18, 2023, which is hereby incorporated by reference in its entirety.

### TECHNICAL FIELD

This disclosure relates generally to wireless communications systems. Embodiments of this disclosure relate to methods and apparatuses for enhanced localization by exploiting carrier phase information.

### BACKGROUND

Indoor positioning has grown in popularity over the last decade in parallel with the growth in the number of personal wireless devices, as well as wireless infrastructure. While the use cases are plentiful and include smart homes and buildings, surveillance, disaster management, industry and healthcare, they all require wide availability and good accuracy.

### SUMMARY

Embodiments of the present disclosure provide methods and apparatuses for enhanced localization by exploiting carrier phase information.

In one embodiment, a method includes obtaining range estimates and carrier phase estimates from each of multiple anchors. The method also includes, in response to determining that a trilateration technique is to be performed, (i) obtaining improved range estimates using the carrier phase estimates and (ii) determining a first location estimate of a target device using the trilateration technique and the improved range estimates. The method also includes, in response to determining that a triangulation technique is to be performed, (i) obtaining differential range estimates using the carrier phase estimates and (ii) determining a second location estimate of the target device using the triangulation technique and the differential range estimates. The method also includes combining the first location estimate and the second location estimate to determine an overall location estimate of the target device.

In another embodiment, a device includes a transceiver and a processor operably connected to the transceiver. The processor is configured to: obtain range estimates and carrier phase estimates from each of multiple anchors; in response to determining that a trilateration technique is to be performed, (i) obtain improved range estimates using the carrier phase estimates and (ii) determine a first location estimate of a target device using the trilateration technique and the improved range estimates; in response to determining that a triangulation technique is to be performed, (i) obtain differential range estimates using the carrier phase estimates and (ii) determine a second location estimate of the target device using the triangulation technique and the differential range estimates; and combine the first location estimate and the second location estimate to determine an overall location estimate of the target device.

In another embodiment, a non-transitory computer readable medium includes program code that, when executed by a processor of a device, causes the device to: obtain range estimates and carrier phase estimates from each of multiple anchors; in response to determining that a trilateration technique is to be performed, (i) obtain improved range estimates using the carrier phase estimates and (ii) determine a first location estimate of a target device using the trilateration technique and the improved range estimates; in response to determining that a triangulation technique is to be performed, (i) obtain differential range estimates using the carrier phase estimates and (ii) determine a second location estimate of the target device using the triangulation technique and the differential range estimates; and combine the first location estimate and the second location estimate to determine an overall location estimate of the target device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example technique for true-range trilateration based localization;

FIG. 4 illustrates an example technique for triangulation based localization;

FIG. 5 illustrates an example system in which enhanced localization by exploiting carrier phase information can be performed according to embodiments of the present disclosure;

FIG. 6 illustrates an example frame exchange for range and sum-carrier phase estimation in a round-trip-time (RTT) method, according to embodiments of the present disclosure;

FIG. 7 illustrates an example frame exchange for range and sum-carrier phase estimation in a round-trip phase (RTP) method, according to embodiments of the present disclosure;

FIG. 8 illustrates a technique of using differential range estimates for improving range estimation, according to embodiments of the present disclosure;

FIG. 9 illustrates a technique of interpreting the differential range estimates as measurements from a virtual antenna array, according to embodiments of the present disclosure;

FIG. 10 illustrates an example system for simulation of triangulation estimation using carrier phase, according to embodiments of the present disclosure;

FIG. 11 illustrates a flow diagram showing an example procedure for improved localization using carrier phase information, according to embodiments of the present disclosure;

FIG. 12 illustrates an example summary algorithm showing the sequential estimation according to embodiments of the present disclosure; and

FIG. 13 illustrates a flowchart of a method for enhanced localization by exploiting carrier phase information according to various embodiments of the present disclosure.

### DETAILED DESCRIPTION

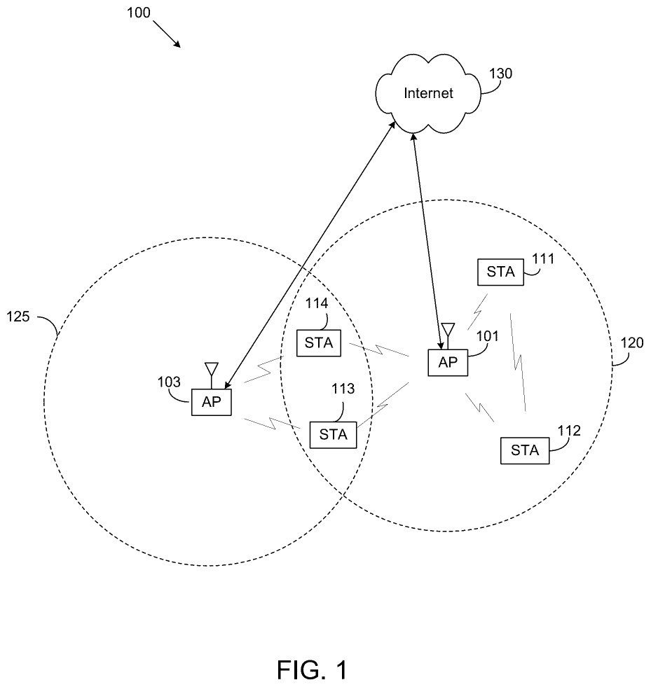

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable enhanced localization by exploiting carrier phase information. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

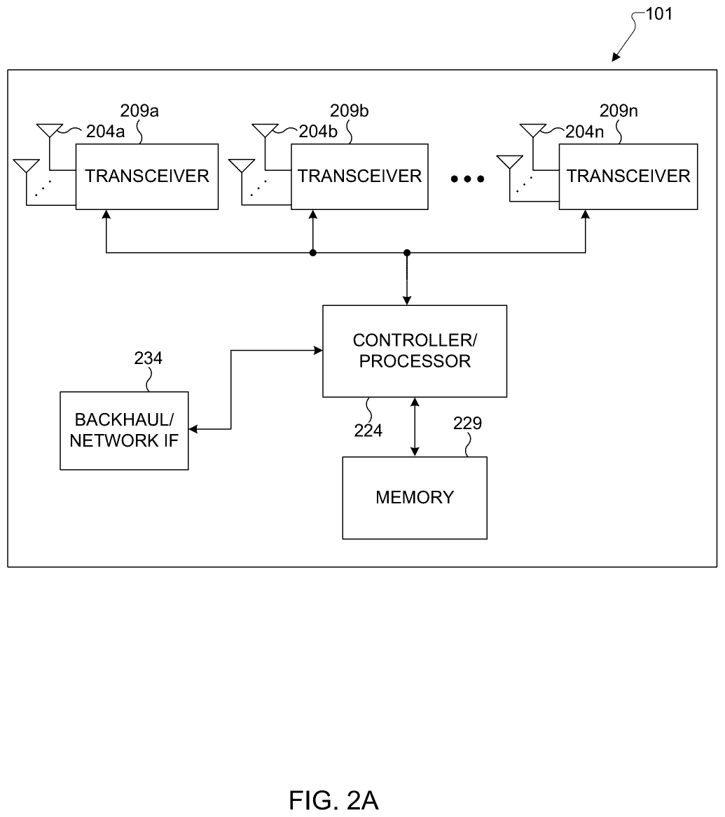

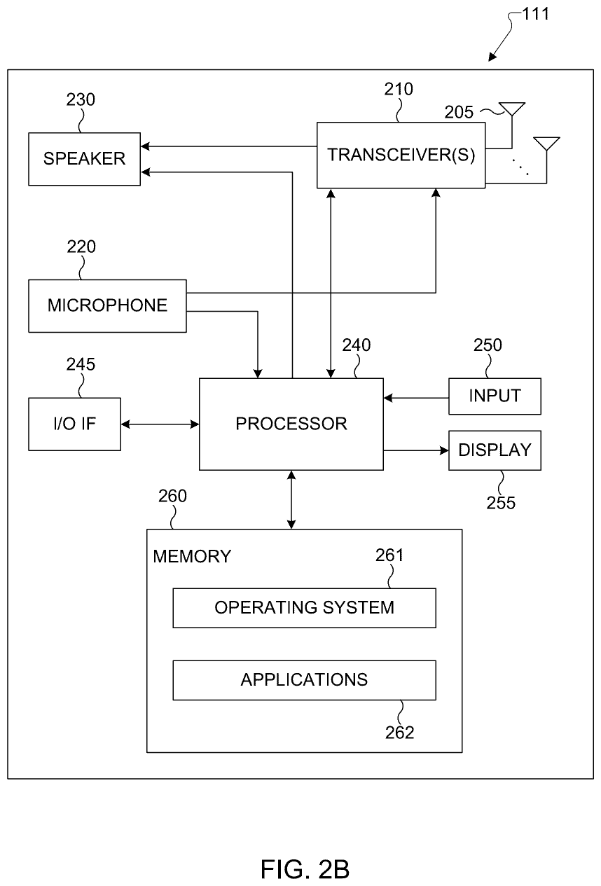

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including enabling enhanced localization by exploiting carrier phase information. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for enhanced localization by exploiting carrier phase information. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable Wi enhanced localization by exploiting carrier phase information. In some embodiments, the processor 240 includes at least one microprocessor or microcontroller.

The processor 240 is also capable of executing other processes and programs resident in the memory 260, such as operations for enabling Wi enhanced localization by exploiting carrier phase information. The processor 240 can move data into or out of the memory 260 as required by an executing process. In some embodiments, the processor 240 is configured to execute a plurality of applications 262, such as applications to enable enhanced localization by exploiting carrier phase information. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As discussed earlier, indoor positioning has grown in popularity over the last decade in parallel with the growth in the number of personal wireless devices, as well as wireless infrastructure. While the use cases are plentiful and include smart homes and buildings, surveillance, disaster management, industry and healthcare, they all require wide availability and good accuracy. Some geometry-based localization methods follow one of the following techniques:

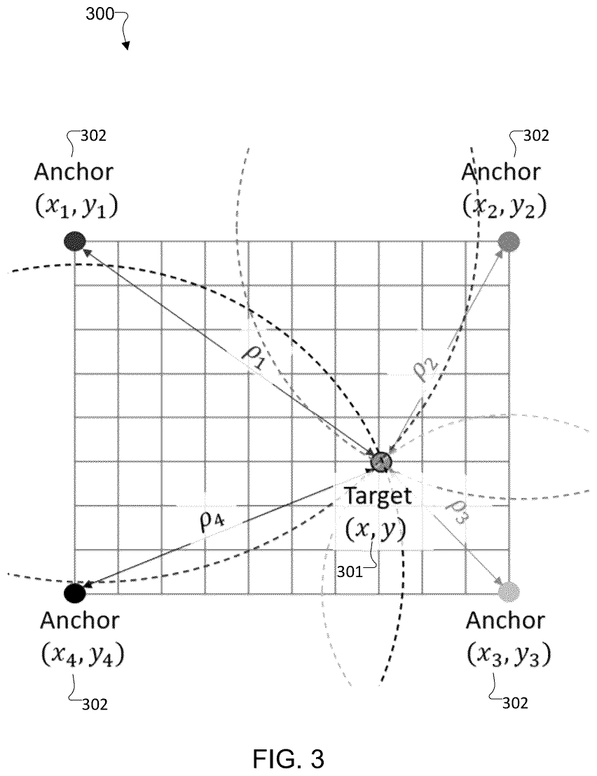

True-range Trilateration: FIG. 3 illustrates an example technique 300 for true-range trilateration based localization. The technique 300 involves measuring or estimating the range (or distance) ρᵢ of a target 301 from a set of anchor nodes (or simply “anchors”) 302 i∈ [symbol] whose locations (xᵢ, yᵢ) are known. These range measurements are then used to localize the target 301. For example, in the two-dimensional case, the target location estimate can be given as (\hat{x}, ŷ) where:

$$( \hat{x} , \hat{y} ) = {arg min}_{x , y} \{ {\sum }_{i ∈} [ {ρ}_{i}^{2} - {( x - {x}_{i} )}^{2} - {( y - {y}_{i} )}^{2} ] \} .$$

For true-range estimation, typically a round trip transmission of signals may be performed between each of the anchors 302 and the target 301. However, the anchors 302 do not need to be synchronized with each other. Several such ranging techniques have been proposed for ultra-wide band (UWB), Lidar, Bluetooth, and Wi-Fi systems. In fact, Wi-Fi standards groups like 802.11mc and 802.11az have been specifically tailored for enabling accurate Wi-Fi-based ranging via the Fine Timing Measurement (FTM) mechanism, etc.

Pseudo-range Trilateration: This technique involves measuring or estimating the relative range Δρᵢ of the target from a set of anchors, i∈ [symbol] \{1} with respect to the range from a reference anchor i=1, where the locations of the anchors (xᵢ, yᵢ) are known. These range measurements are then used to localize the target. For example, in the two-dimensional case, the target location estimate can be given as (\hat{x}, ŷ) where:

$$( \hat{x} , \hat{y} ) = {arg min}_{x , y} \{ {min}_{{ρ}_{1}} [ {\sum }_{i ∈} [ {( {ρ}_{1} + Δ {ρ}_{i} )}^{2} - {( x - {x}_{i} )}^{2} - {( y - {y}_{i} )}^{2} ] ] \} .$$

For pseudo-range estimation, it is sufficient for the target to transmit a signal that can be received at all the anchors, or alternatively, for a set of anchors to transmit a signal that can be received by a target. Here, a round-trip signal transmission may not be required, unlike in the case of true range, but the anchors may need to be synchronized. An example of this is the GPS system. Note that a true-range estimation method such as Wi-Fi FTM essentially functions as a pseudo-range estimation method if pre-calibration steps are not performed.

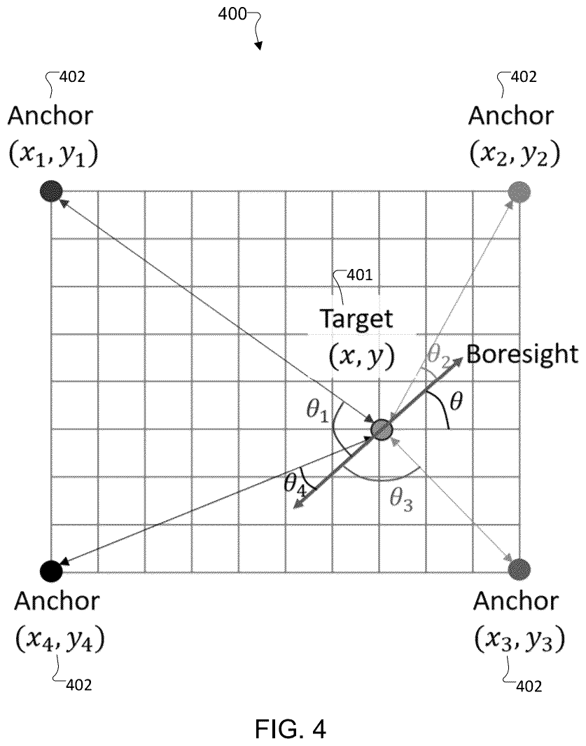

Triangulation: FIG. 4 illustrates an example technique 400 for triangulation based localization. The technique 400 involves measuring or estimating the azimuth angles θᵢ (and optionally elevation angles) that the line-of-sight paths from a set of anchors 402 i ϵ [symbol] , whose locations (xᵢ, yᵢ) are known, subtend at a target 401 (or vice versa). Here the angles may be measured with respect to the target 401's unknown boresight direction θ and it may be true that

$${θ}_{i} ∈ [ - \frac{π}{2} , \frac{π}{2} ) .$$

These angle measurements are then used to localize the target 401. For example, in the two-dimensional case, the target location estimate can be given as (\hat{x}, ŷ) where:

$$( \hat{x} , \hat{y} ) = {argmin}_{x , y} {min}_{0 \leq θ < 2 π} \{ {\sum }_{i ∈} {[ {tan}^{- 1} ( \frac{( {y}_{i} - y ) cos θ - ( {x}_{i} - x ) sin θ}{\vert ( {y}_{i} - y ) sin θ + ( {x}_{i} - x ) cos θ} ) - {θ}_{i} ]}^{2} \} .$$

Triangulation can be performed by the target 401 transmitting a signal to the set of anchors 402 or vice-versa, but the anchors 402 do not need to be synchronized. However multiple antenna elements may be needed at the anchors 402 or the target 401 to perform the estimation of the azimuth or elevation angles. Examples of this method include LTE triangulation used by cellular networks.

Each of these geometry-based techniques may have their respective advantages and disadvantages, as shown in Table 1.

TABLE 1
Advantages and Disadvantages of Localization Techniques

| | Trilateration | Triangulation |
|---|---|---|
| Impact of signal- | Performance degrades | Performance degrades |
| to-noise ratio | with reduction in | with reduction in |
| (SNR) | SNR. | SNR. |
| Impact of | Performance is limited | Performance does not |
| bandwidth (for | by the accuracy of the | depend on the bandwidth |
| fixed SNR) | range estimates ρᵢ, | of the signal being |
| | which is limited by the | transmitted to perform |
| | bandwidth of the signal | the angle estimation. |
| | being transmitted to | |
| | perform the range | |
| | estimation. | |
| Impact of anchor- | Performance doesn't | Performance does degrade |
| target distance | degrade with anchor- | with anchor-target |
| (for fixed SNR) | target distance. | distance. |
| Impact of number | Performance doesn't | Performance improves with |
| of antennas and | depend on number of | the number of antennas and |
| antenna aperture | antennas or the size | size of antenna array. |
| (at target or | of antenna array. | (can't be used with single |
| anchors) | | antenna systems) |
| Impact of multi- | Performance is more | Performance is less robust |
| path in the | robust to multi-path. | to multi-path. |
| channel | | |

Among the geometry-based localization techniques, trilateration techniques may provide poor accuracy when the bandwidth of the signals being used is low. Similarly, the triangulation techniques only work if either the anchors or the target have multiple antennas and need sufficient aperture size to improve estimation. This can limit the performance of localization in some technologies like Wi-Fi and Bluetooth, which may have a low bandwidth (≤80 MHz) and may have at most one or two antennas at the target and/or anchors.

To address these and other issues, this disclosure provides systems and methods for enhanced localization by exploiting carrier phase information. As described in more detail below, the disclosed embodiments use carrier phase measurements during the ranging process to improve the accuracy of the range estimates and thus also trilateration. The disclosed embodiments also use carrier phase measurements during the ranging process to enable triangulation-based ranging even with single antennas at the anchors and the target. The disclosed embodiments can also use a weighted combination of at least one of an objective function or outputs from triangulation and trilateration estimation to obtain a location result, where weights of the weighted combination are determined based on at least one of an available bandwidth, an operating SNR, an accuracy of CFO estimation, or an available computation complexity.

The disclosed embodiments provide multiple advantageous benefits over some systems, including improving the performance of trilateration-based localization and enable triangulation-based localization without the need for multiple antennas.

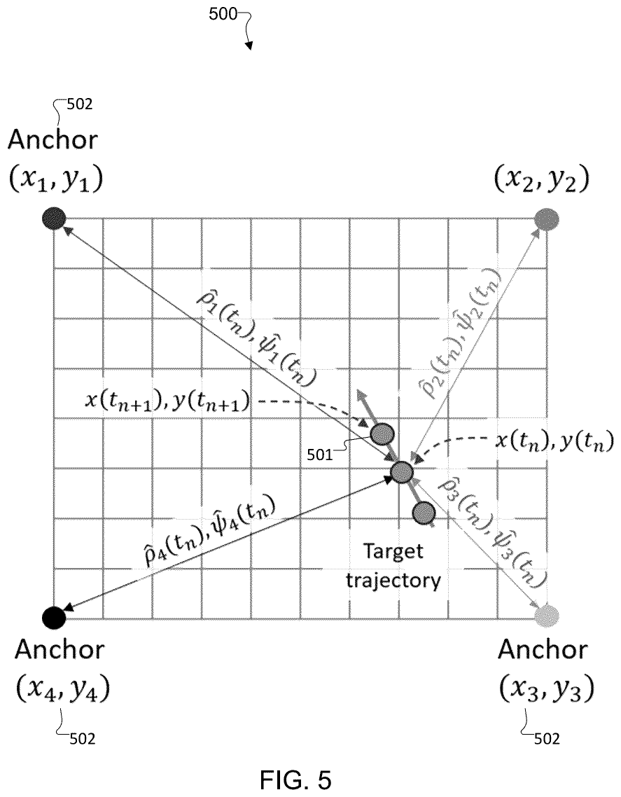

FIG. 5 illustrates an example system 500 in which enhanced localization by exploiting carrier phase information can be performed according to embodiments of the present disclosure. As shown in FIG. 5, the system 500 includes a target device 501 and multiple anchors 502. In the system 500, the locations of the target device 501 and the anchors 502 are represented in a two-dimensional Cartesian coordinate system, in which there is a X-direction and a Y-direction and a concept of an origin location (0,0). The anchors 502 can be single-antenna anchors indexed as [symbol] ={1,2 . . . , I} at known locations (xᵢ, yᵢ), while the target device 501 can be a single-antenna target whose location (x(t), y(t)) has to be estimated and tracked as a function of time t. Although the details below are provided assuming a two-dimensional localization system, this disclosure is not limited thereto, and the embodiments described herein are applicable to a higher dimensional localization system. In some embodiments, the anchors 502 and the target device 501 may not be synchronized with respect to each other.

### Measurement Collection

For performing the localization, the target device 501 performs a frame exchange with each of the anchors 502 i∈ [symbol] at regular time intervals: t₁, t₂, . . . , t_{N} etc. Using the frame exchanges at time tₙ the target device 501 can obtain estimates of its range {\hat{ρ}ᵢ(tₙ)|i∈ [symbol] } and sum-carrier phase {\hat{ψ}ᵢ(tₙ)|i∈ [symbol] } from each of the anchors 502, as shown in FIG. 5. Here, the sum-carrier phase \hat{ψ}ᵢ(tₙ) is the sum of the channel phase angle at the carrier frequency ƒ_{c}, measured at anchor i (i.e., one of the anchors 502) for the signal transmission from the target device 501 at time tₙ and at the target device 501 for the signal transmission from anchor i at time tₙ, after correcting for any carrier-frequency-offset (CFO) based phase rotation, if applicable. This measurement model can be applicable for a variety of technologies or methods. Some examples of such measurement are provided below for illustration.

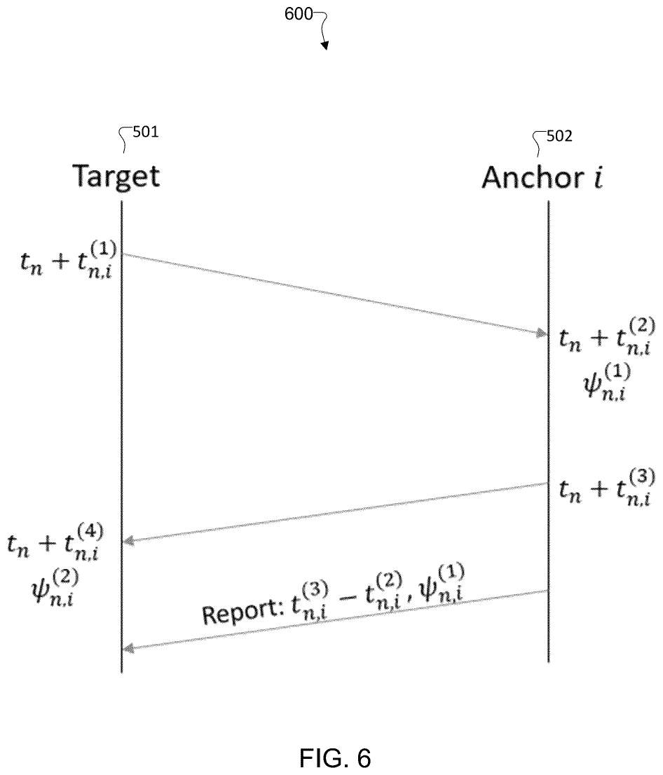

In one example, the target device 501 may transmit a signal to anchor i at time tₙ+t_{n,i}⁽¹⁾ (as measured by the target device 501). This frame may be received by the anchor i at time tₙ+t_{n,i}⁽²⁾ (as measured by the anchor i) as part of a frame exchange. FIG. 6 illustrates an example frame exchange 600 for range and sum-carrier phase estimation in a round-trip-time (RTT) method, according to embodiments of the present disclosure. In addition, using the received signal, the anchor i may also measure the phase of the channel ψ_{n,i}⁽¹⁾ at the carrier frequency ƒ_{c}. Subsequently, the anchor i may transmit a signal to the target device 501 at time tₙ+t_{n,i}⁽³⁾ (as measured by the anchor i). This frame may be received by the target device 501 at time tₙ+t_{n,i}⁽⁴⁾ (as measured by the target device 501). In addition, using the received signal, the target device 501 may also measure the phase of the channel ψ_{n,i}⁽²⁾ at the carrier frequency ƒ_{c} and the carrier frequency offset (CFO) \hat{ƒ}_{CFO,i} of the target device 501 with respect to the anchor i. Note that the times t_{n,i}⁽¹⁾, . . , t_{n,i}⁽⁴⁾ may be much smaller than tₙ. Then by exchanging the values of t_{n,i}⁽⁴⁾−t_{n,i}⁽¹⁾, t_{n,i}⁽³⁾−t_{n,i}⁽²⁾, ψ_{n,i}⁽¹⁾, ψ_{n,i}⁽²⁾, \hat{ƒ}_{CFO,i}, the target device 501 (or the anchor i) can estimate the range and sum-carrier phase, respectively as:

$${\hat{ρ}}_{i} ( {t}_{n} ) = [ ( {t}_{n , i}^{( 4 )} - {t}_{n , i}^{( 1 )} ) - ( {t}_{n , i}^{( 3 )} - {t}_{n , i}^{( 2 )} ) ] \times 1.5 \times {10}^{8} ( in meters ) , \\ {\hat{ψ}}_{i} ( {t}_{n} ) = {ψ}_{n , i}^{( 1 )} + {ψ}_{n , i}^{( 2 )} - 2 π {f}_{CFO , i} ( {t}_{n , i}^{( 4 )} - {t}_{n , i}^{( 1 )} ) ( in radians ) .$$

Note that this model is directly applicable to most RTT methods such as the Wi-Fi Fine Time Measurement (FTM) protocol (with appropriate modifications to enable reporting of the carrier phase values).

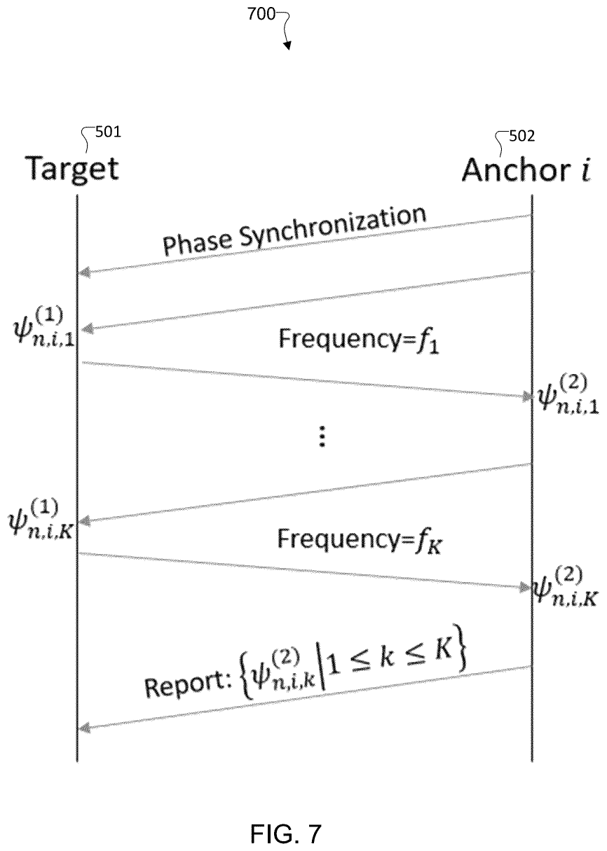

In another example, at time tₙ, the anchor i first transmits a synchronization signal to the target device 501 to enable the target device 501 to synchronize its local oscillator with the anchor's oscillator. After this, the anchor i and the target device 501 perform frequency hopping on a set of K frequencies ƒ₁, . . . , ƒ_{K}. On each frequency k, the anchor i first transmits a known signal, and the target device 501 measures the phase of the received signal: ψ_{n,i,k}⁽¹⁾. FIG. 7 illustrates an example frame exchange 700 for range and sum-carrier phase estimation in a round-trip phase (RTP) method, according to embodiments of the present disclosure. Subsequently, the target device 501 transmits a known signal, and the anchor i measures the phase of the received signal: ψ_{n,k}⁽²⁾. Then by exchanging the values of {ψ_{n,i,k}⁽¹⁾, ψ_{n,i,k}⁽²⁾|1≤k≤K}, the target device 501 (or the anchor i) can estimate the range as either:

$${\hat{ρ}}_{i} ( {t}_{n} ) = {argmin}_{ρ ∈ P} \{ {min}_{0 \leq ψ < 2 π} {\sum }_{k = 1}^{K} {[ mod \{ {ψ}_{n , i , k}^{( 1 )} + {ψ}_{n , i , k}^{( 2 )} - \overline{ψ} - \frac{4 πρ ( {f}_{k} - {f}_{c} )}{3 \times {10}^{8}} + π , 2 π \} - π ]}^{2} \} ,$$

$$or :$$

$${\hat{ρ}}_{i} ( {t}_{n} ) = {argmin}_{ρ ∈ P} {min}_{0 \leq ψ < 2 π} Re \{ {\sum }_{k = 1}^{K} exp [ j ( {ψ}_{n , i , k}^{( 1 )} + {ψ}_{n , i , k}^{( 2 )} - \overline{ψ} - \frac{4 πρ ( {f}_{k} - {f}_{c} )}{3 \times {10}^{8}} ) ] \} ,$$

where ƒ_{c} is a reference frequency in the middle of the hopping frequency range (referred to here as carrier frequency), P is a search range for the range estimation, and \hat{ρ}ᵢ(tₙ) is the range given in meters. Similarly, the sum-carrier phase can be estimated as:

\hat{ψ}ᵢ(tₙ)=ψ̅ (in radians),

where the value of ψ̅ corresponds to the optimal solution in the estimation of \hat{ρ}ᵢ(tₙ) above. Note that this model is directly applicable to any round-trip phase (RTP) method such as frequency-hopping protocol in Bluetooth Low Energy devices.

Let the true range of the target device 501 from the anchor i∈ [symbol] at time tₙ be given by:

[symbol]

Then it can be shown that the estimates of the range and sum-carrier phase can be related to the true range as:

$${\hat{ρ}}_{i} ( {t}_{n} ) = {ρ}_{i} ( {t}_{n} ) + {ϵ}_{i} ( {t}_{n} ) , \\ {\hat{ψ}}_{i} ( {t}_{n} ) = mod \{ \frac{4 {πρ}_{i} ( {t}_{n} ) {f}_{c}}{3 \times {10}^{8}} + C , 2 π \} + {δ}_{i} ( {t}_{n} ) ,$$

where ϵᵢ(tₙ) and δᵢ(tₙ) are estimation errors and C is an unknown constant. It can be shown that the error term ϵᵢ(tₙ) reduces with an increase in measurement SNR and the signal bandwidth (or max-frequency range in case of frequency hopping). Similarly, it can be shown that the error term δᵢ(tₙ) reduces with an increase in measurement SNR and accuracy of CFO estimation (or accuracy of oscillator synchronization in case of frequency hopping).

In some embodiments, the measurements {\hat{ρ}ᵢ(tₙ), \hat{ψ}ᵢ(tₙ)|i∈ [symbol] } are collected for a sequence of time stamps t₁, . . . , t_{N} and are used to estimate the trajectory of the target device 501: (x(t₁), y(t₁)), . . . , (x(t_{N}), y(t_{N})).

### Trilateration-Based Localization

In some embodiments, it may be first determined if trilateration-based localization should be performed. Such a determination can be based on, for example, the amount of error in the range estimates \hat{ρ}ᵢ(tₙ), the accuracy of the clock, the amount of variation in the carrier phase values \hat{ψ}ᵢ(tₙ) across the N time samples, or the like.

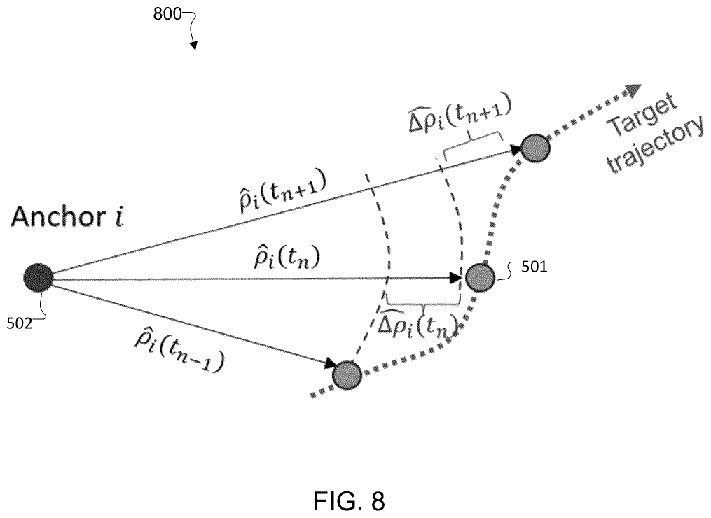

If it is determined to perform trilateration, then in some embodiments, the carrier phase estimates can be used to obtain estimates of the differential range as:

$$( {t}_{n} ) {=}^{Δ} \frac{3 \times {10}^{8}}{4 π {f}_{c}} [ {\hat{ψ}}_{i} ( {t}_{n} ) - {\hat{ψ}}_{i} ( {t}_{n - 1} ) ] \approx {ρ}_{i} ( {t}_{n} ) - {ρ}_{i} ( {t}_{n - 1} ) ,$$

where the result follows under the case that the time-difference between measurements tₙ−tₙ₋₁ is small enough that the range does not change by more than half a carrier-wavelength between two measurements. These differential range measurements can then be used to obtain improved range estimates ρ̅ᵢ(tₙ), via appropriate temporal averaging. As an example, FIG. 8 illustrates a technique 800 of using differential range estimates for improving range estimation, according to embodiments of the present disclosure. As shown in FIG. 8, such estimation can be performed as:

$${\overline{ρ}}_{i} ( {t}_{n} ) = λ {\hat{ρ}}_{i} ( {t}_{n} ) + ( 1 - λ ) ( {\hat{ρ}}_{i} ( {t}_{n - 1} ) + ( {t}_{n} ) ) ,$$

where 0≤λ≤1 is a combining weight.

$${\overline{ρ}}_{i} ( {t}_{n} ) = {\sum }_{a = - A}^{- 1} {λ}_{a} ( {\hat{ρ}}_{i} ( {t}_{n + a} ) + {\sum }_{b = a + 1}^{0} ( {t}_{n + b} ) ) {λ}_{0} {\hat{ρ}}_{i} ( {t}_{n} ) + {\sum }_{a = 1}^{A} {λ}_{a} ( {\hat{ρ}}_{i} ( {t}_{n + a} ) - {\sum }_{b = 1}^{a} ( {t}_{n + b} ) ) ,$$

where Σ_{a=-A}^{A}λₐ=1 are weights for different neighboring range estimates.

Another method can be to feed \hat{ρ}ᵢ(tₙ) and [symbol] (tₙ) independently as the range and velocity estimates to a Kalman filter or a particle filter, which then combines the estimates from t₁ to t_{N} perform an estimation of the improved ranges ρ̅ᵢ(t₁), . . . , ρ̅ᵢ(t_{N}).

Note that these improved range estimates may have a much lower error by means of averaging across the time domain. Such averaging may not be possible without the carrier phase estimates \hat{ψ}ᵢ(tₙ) which are used to estimate the differential range [symbol] (tₙ). These improved range estimates can then be used to perform trilateration to estimate (x(tₙ), y(tₙ)) using any existing trilateration algorithm. For example, the estimate can be obtained as the solution to:

$$( \hat{x} ( {t}_{n} ) , \hat{y} ( {t}_{n} ) ) = {argmin}_{x , y} \{ {\sum }_{i ∈} [ {( {\overline{ρ}}_{i} ( {t}_{n} ) - {B}_{i} )}^{2} - {( x - {x}_{i} )}^{2} - {( y - {y}_{i} )}^{2} ] \} ,$$

where Bᵢ is any applicable bias or calibration term applicable to anchor i as reported by the anchor. In other embodiments, if there is an unknown bias for the target device 501, the estimation can be modified to a pseudo-range-based trilateration algorithm as:

$$( \hat{x} ( {t}_{n} ) , \hat{y} ( {t}_{n} ) ) = {argmin}_{x , y} \{ {min}_{{B}_{0}} [ {\sum }_{i ∈} [ {( {\overline{ρ}}_{i} ( {t}_{n} ) - {B}_{i} - {B}_{0} )}^{2} - {( x - {x}_{i} )}^{2} - {( y - {y}_{i} )}^{2} ] ] \} .$$

In other embodiments, a motion model can be considered that within M neighboring time samples of a sample tₙ, the velocity of the target device 501 remains the same. Correspondingly for any time sample n, let us define [symbol] ₙ={1≤m≤N∥m−n|≤M} as a set of samples in its neighborhood that share a similar (but unknown) velocity. It can be shown that:

$$( x ( {t}_{m} ) , y ( {t}_{m} ) ) \approx ( x ( {t}_{n} ) + {v}_{X} \times [ {t}_{m} - {t}_{n} ] , y ( {t}_{n} ) + {v}_{Y} \times [ {t}_{m} - {t}_{n} ] )$$

where v_{X} and v_{Y} represent the unknown velocity of the target device 501 during the time sequence along the X and Y directions, respectively, in the vicinity of the sample n. Then the location can be estimated as:

$$\hat{x} ( {t}_{n} ) , \hat{y} ( {t}_{n} ) = {argmin}_{x , y} {min}_{u , v} \{ {\sum }_{i ∈ 𝒥} {\sum }_{m ∈ {ℳ}_{n}} [ {( {\overline{ρ}}_{i} ( {t}_{m} ) - {B}_{i} )}^{2} - {( x + u \times ( {t}_{m} - {t}_{n} ) - {x}_{i} )}^{2} - {( y + v \times ( {t}_{m} - {t}_{n} ) - {y}_{i} )}^{2} ] \} .$$

In a variant of these embodiments, prior estimates of the velocity \tilde{v}_{X}, \tilde{v}_{Y} may be available from the inertial motion sensor, accelerometer, compass, and gyroscope at the target device 501, or from localization results of prior time samples. In this case, the estimation may be modified as:

$$\hat{x} ( {t}_{n} ) , \hat{y} ( {t}_{n} ) = {argmin}_{x , y} {min}_{u , v} \{ μ [ {( u - {\tilde{v}}_{X} )}^{2} + {( v - {\tilde{v}}_{Y} )}^{2} ] + {\sum }_{i ∈ 𝒥} {\sum }_{m ∈ {ℳ}_{n}} [ {( {\overline{ρ}}_{i} ( {t}_{m} ) - {B}_{i} )}^{2} - {( x + u \times ( {t}_{m} - {t}_{n} ) - {x}_{i} )}^{2} - {( y + v \times ( {t}_{m} - {t}_{n} ) - {y}_{i} )}^{2} ] \} .$$

where μ is a predetermined weighting factor.

These estimates (\hat{x}(tₙ), ŷ(tₙ)) for the time sequence t₁, . . . , t_{N} may further be fed to a Kalman filter or a particle filter, etc., with an appropriate state evolution model that captures the feasible space for motion of the target device 501 to improve the localization result.

### Triangulation-Based Localization

In some embodiments, triangulation-based localization may be performed only if there is sufficient variation in the value of \hat{ψ}ᵢ(tₙ) over the time instances t₁, . . . , t_{N} indicating a change in position. This determination can be made, for example based on:

$${\sum }_{n = 1}^{N} {\vert {e}^{j {\hat{ψ}}_{i} ( {t}_{n} )} - \frac{1}{N} {\sum }_{m = 1}^{N} {e}^{j {\hat{ψ}}_{i} ( {t}_{m} )} \vert}^{2} > Threshold$$

In other embodiments, the need for accurate localization and available computation power may also be taken into consideration to determine whether or not to perform triangulation-based localization.

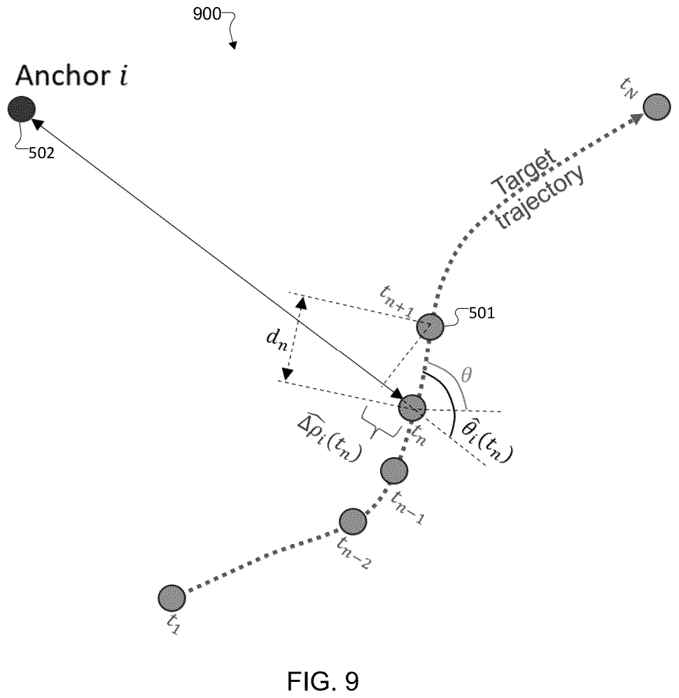

If it is determined to use triangulation-based localization, then in some embodiments, the carrier phase measurements can be used to measure the differential range as (as defined previously):

$$( {t}_{n} ) {=}^{Δ} \frac{3 \times {10}^{8}}{4 π {f}_{c}} [ {\hat{ψ}}_{i} ( {t}_{n} ) - {\hat{ψ}}_{i} ( {t}_{n - 1} ) ] \approx {ρ}_{i} ( {t}_{n} ) - {ρ}_{i} ( {t}_{n - 1} ) ,$$

where the result follows under the case that the time-difference between measurements tₙ−tₙ₋₁ is small enough for each n that the range does not change by more than half a carrier-wavelength between two measurements. Note that if the locations (x(tₙ), y(tₙ)) for the N time instances are interpreted as locations of a virtual antenna array, then [symbol] (tₙ) captures the additional distance travelled by a signal as it arrives at a virtual antenna element n with respect to a virtual antenna element n−1, if the signal is transmitted from anchor i. As an example, FIG. 9 illustrates a technique 900 of interpreting the differential range estimates as measurements from a virtual antenna array, according to embodiments of the present disclosure. As shown in FIG. 9, [symbol] (tₙ) can be used to estimate the angle of arrival of the path from anchor i to the target device 501 at time tₙ (measured with respect to the direction of motion of the target device 501) as:

$$\\ {\hat{θ}}_{i} ( {t}_{n} ) = {cos}^{{}_{} - 1} ( \frac{{}_{} ( {t}_{n} )}{{d}_{n}} ) ,$$

if the inter-element distances dₙ are known.

In some embodiments, a modified version of triangulation algorithms can be used (with hidden variables for the inter-element distance dₙ and trajectory direction θ) to estimate \hat{x}(tₙ), ŷ(tₙ). For example, the location estimate can be obtained as:

$$\\ \hat{x} ( {t}_{n} ) , \hat{y} ( {t}_{n} ) = {arg min}_{x , y} {min}_{d , 0 \leq θ < 2 π} \{ {\sum }_{i {}_{} ∈ {}_{} 𝒥} {[ {cos}^{{}_{} - 1} ( \frac{( {y}_{i} - y ) sin θ + ( {x}_{i} - x ) cos θ}{\sqrt{{( {x}_{i} - x )}^{2} + {( {y}_{i} - y )}^{2}}} ) - {cos}^{{}_{} - 1} ( \frac{{}_{} ( {t}_{n} )}{{d}_{n}} ) ]}^{{}_{} 2} \} .$$

In another example, the location estimate can be obtained as:

$$\\ \hat{x} ( {t}_{n} ) , \hat{y} ( {t}_{n} ) = {arg min}_{x , y} {min}_{d , 0 \leq θ < 2 π} \{ {\sum }_{i {}_{} ∈ {}_{} 𝒥} {[ \sqrt{{( {x}_{i} - x )}^{2} + {( {y}_{i} - y )}^{2}} - \sqrt{{( {x}_{i} - x - d cos θ )}^{2} + {( {y}_{i} - y - d sin θ )}^{2}} - {}_{} ( {t}_{n} ) ]}^{{}_{} 2} \} .$$

Methods to simplify this computation can be used when the differential range is small compared to the true range.

In a variant of these embodiments, the goal can be finding the direction of the line-of-sight path from the target device 501 to the anchor i (known as the direction-finding problem) instead of localization. In this case,

$$\\ {\hat{θ}}_{i} ( {t}_{n} ) = {cos}^{{}_{} - 1} ( \frac{{}_{} ( {t}_{n} )}{{d}_{n}} )$$

is the desired estimate.

In other embodiments, the speed sₙ and direction θₙ of travel of the target device 501 between two neighboring time steps tₙ₋₁ to tₙ may be available using side information, such as from the estimates of s, θ from previous time steps, or from an inertial motion sensor, accelerometer, compass and/or gyroscope. In this case, the location estimates of the target device 501 can be obtained by feeding the angles

$$\\ {\hat{θ}}_{i} ( {t}_{n} ) = {cos}^{{}_{} - 1} ( \frac{{}_{} ( {t}_{n} )}{{s}_{n} ( {t}_{n} - {t}_{n - 1} )} )$$

to any suitable triangulation algorithm. For example, the following may be used:

$$\\ \hat{x} ( {t}_{n} ) , \hat{y} ( {t}_{n} ) = {arg min}_{x , y} {}_{} \{ {\sum }_{i {}_{} ∈ {}_{} 𝒥} {[ {cos}^{{}_{} - 1} ( \frac{( {y}_{i} - y ) sin {θ}_{n} + ( {x}_{i} - x ) cos {θ}_{n}}{\sqrt{{( {x}_{i} - x )}^{2} + {( {y}_{i} - y )}^{2}}} ) - {cos}^{{}_{} - 1} ( \frac{{}_{} ( {t}_{n} )}{{s}_{n} ( {t}_{n} - {t}_{n - 1} )} ) ]}^{{}_{} 2} \} .$$

In another example, the location estimate can be obtained as:

$$\\ \hat{x} ( {t}_{n} ) , \hat{y} ( {t}_{n} ) = {arg min}_{x , y} {}_{} \{ {\sum }_{i {}_{} ∈ {}_{} 𝒥} {[ \sqrt{{( {x}_{i} - x )}^{2} + {( {y}_{i} - y )}^{2}} - \sqrt{{( {x}_{i} - x - {s}_{n} ( {t}_{n} - {t}_{n - 1} ) cos {θ}_{n} )}^{2} + {( {y}_{i} - y - {s}_{n} ( {t}_{n} - {t}_{n - 1} ) sin {θ}_{n} )}^{2}} - {}_{} ( {t}_{n} ) ]}^{{}_{} 2} \} .$$

In a variant of these embodiments, if the estimates of the speed sₙ and direction θₙ are noisy, the location estimate can be obtained as:

$$\\ \hat{x} ( {t}_{n} ) , \hat{y} ( {t}_{n} ) = {arg min}_{x , y} {min}_{d , 0 \leq θ < 2 π} \{ {{μ}_{1} ( d - {s}_{n} ( {t}_{n} - {t}_{n - 1} ) )}^{2} + {{μ}_{2} ( θ - {θ}_{n} )}^{2} + {\sum }_{i {}_{} ∈ {}_{} 𝒥} {[ {cos}^{{}_{} - 1} ( \frac{( {y}_{i} - y ) sin θ + ( {x}_{i} - x ) cos θ}{\sqrt{{( {x}_{i} - x )}^{2} + {( {y}_{i} - y )}^{2}}} ) - {cos}^{{}_{} - 1} ( \frac{{}_{} ( {t}_{n} )}{d} ) ]}^{{}_{} 2} \} .$$

$$\\ or :$$

$$\\ \hat{x} ( {t}_{n} ) , \hat{y} ( {t}_{n} ) = {arg min}_{x , y} {min}_{d , 0 \leq θ < 2 π} \{ {{μ}_{1} ( d - {s}_{n} ( {t}_{n} - {t}_{n - 1} ) )}^{2} + {{μ}_{2} ( θ - {θ}_{n} )}^{2} + {\sum }_{i {}_{} ∈ {}_{} 𝒥} {[ \sqrt{{( {x}_{i} - x )}^{2} + {( {y}_{i} - y )}^{2}} - \sqrt{{( {x}_{i} - x - d cos θ )}^{2} + {( {y}_{i} - y - d sin θ )}^{2}} - {}_{} ( {t}_{n} ) ]}^{{}_{} 2} \} .$$

where μ₁, μ₂ are weighting coefficients.

In other embodiments, a motion model can be considered that within M neighboring time samples of a sample tₙ, the velocity of the target device 501 remains the same. Correspondingly for any time sample n, let us define [symbol] ₙ={1≤m≤N∥m−n|≤M} as a set of samples in its neighborhood that share a similar (but unknown) speed s and pointing direction θ. Then a modified version of triangulation algorithms can be used (with hidden variables for the speed and pointing direction) to estimate \hat{x}(tₙ), ŷ(tₙ). For example, the location estimate can be obtained as:

$$\\ \hat{x} ( {t}_{n} ) , \hat{y} ( {t}_{n} ) = {arg min}_{x , y} {min}_{s , 0 \leq θ < 2 π} \{ {\sum }_{i {}_{} ∈ {}_{} 𝒥} {[ {cos}^{{}_{} - 1} ( \frac{( {y}_{i} - y ) sin θ + ( {x}_{i} - x ) cos θ}{\sqrt{{( {x}_{i} - x )}^{2} + {( {y}_{i} - y )}^{2}}} ) - {cos}^{{}_{} - 1} ( {\sum }_{m ∈ {ℳ}_{n}} \frac{{}_{} ( {t}_{m} )}{\vert \vert ( {t}_{m} - {t}_{m - 1} ) s} ) ]}^{{}_{} 2} \} ,$$

$$\\ or :$$

$$\\ \hat{x} ( {t}_{n} ) , \hat{y} ( {t}_{n} ) = {arg min}_{x , y} {min}_{0 \leq θ < 2 π} \{ {\sum }_{i {}_{} ∈ {}_{} 𝒥} {\sum }_{m ∈ {ℳ}_{n}} {[ {cos}^{{}_{} - 1} ( \frac{( {y}_{i} - y ) sin θ + ( {x}_{i} - x ) cos θ}{\sqrt{{( {x}_{i} - x )}^{2} + {( {y}_{i} - y )}^{2}}} ) - {cos}^{{}_{} - 1} ( \frac{{}_{} ( {t}_{m} )}{( {t}_{m} - {t}_{m - 1} ) s} ) ]}^{{}_{} 2} \} .$$

In another example, the location estimate can be obtained as:

$$\\ \hat{x} ( {t}_{n} ) , \hat{y} ( {t}_{n} ) = {arg min}_{x , y} {min}_{d , 0 \leq θ < 2 π} \{ {\sum }_{i {}_{} ∈ {}_{} 𝒥} {\sum }_{m ∈ {ℳ}_{n}} {[ \sqrt{{( {x}_{i} - x - ( {t}_{m} - {t}_{n} ) s cos θ )}^{2} + {( {y}_{i} - y - ( {t}_{m} - {t}_{n} ) s sin θ )}^{2}} - \sqrt{{( {x}_{i} - x - ( {t}_{m - 1} - {t}_{n} ) s cos θ )}^{2} + {( {y}_{i} - y - ( {t}_{m - 1} - {t}_{n} ) s sin θ )}^{2}} - {}_{} ( {t}_{m} ) ]}^{2} \} .$$

Methods to simplify this computation can be used when the differential range is small compared to the true range.

These estimates (\hat{x}(tₙ), ŷ(tₙ)) for the time sequence t₁, . . . , t_{N} may further be fed to a Kalman filter or a particle filter with appropriate state evolution model that captures the feasible space for motion of the target device 501.

### Combining the Two Localization Results

In some embodiments, a weighted combination of the localization result from trilateration and triangulation can be used to obtain the final location result. The combining weights may be determined based on available bandwidth, operating SNR, accuracy of the CFO estimation and available computation complexity.

### Calibration of Ranging Bias

In some embodiments, if the ranging bias values {B₀+Bᵢ|i∈ [symbol] } used in trilateration are not shared by the anchors 502 to the target device 501, the target device 501 may use the location result from triangulation (\hat{x}(tₙ), ŷ(tₙ)) as the true location, and then fit the best bias values B₀+Bᵢ that provide the closest localization result via trilateration. Note that since the bias values are constant, the fit can be performed using the data triangulation and trilateration results from a large number of samples to reduce the estimation noise.

### Simulations on Triangulation

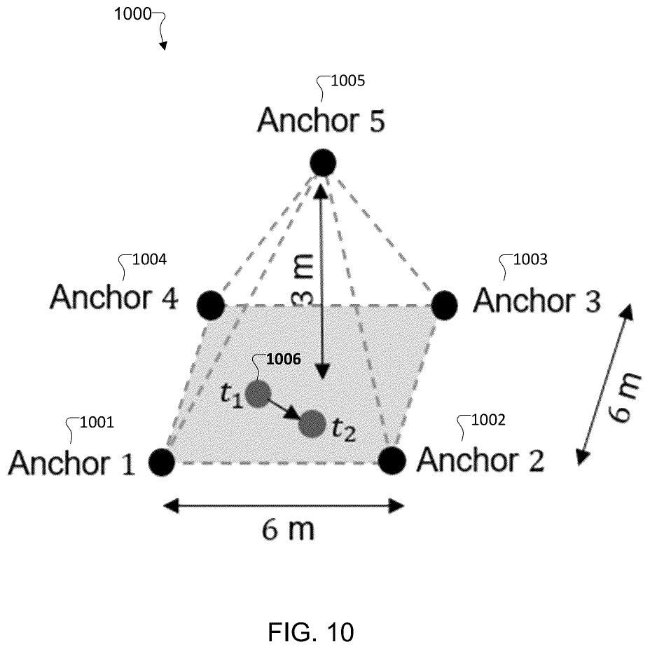

FIG. 10 illustrates an example system 1000 for simulation of triangulation estimation using carrier phase, according to embodiments of this disclosure. As shown in FIG. 10, the system 1000 includes five anchors 1001-1005 arranged in a pyramidal structure and a target device 1006. The locations of the anchors 1001-1005 are (0,0,0), (0,6,0), (6,0,0), (6,6,0), (3,3,3), and the target device 1006 starts at time t₁ from an arbitrary position on the X-Y plane (x(t₁), y(t₁)).

Between time sample t₁ and time sample t₂, the target device 1006 moves a distance d in a direction θ, which are assumed to be unknown. This can be represented mathematically as: (x(t₂), y(t₂))=(x(t₁)+d cos θ, y(t₁)+d sin θ). It is assumed that accurate values of the differential range [symbol] (t₂) are available from each anchor i as:

$$\\ {}_{} ( {t}_{2} ) = \sqrt{{( {x}_{i} - x ( {t}_{2} ) )}^{2} + {( {y}_{i} - x ( {t}_{2} ) )}^{2}} - \sqrt{{( {x}_{i} - x ( {t}_{1} ) )}^{2} + {( {y}_{i} - x ( {t}_{1} ) )}^{2}}$$

Then, for all feasible values of x, y, in the shaded region in the X-Y plane shown in FIG. 10, the objective function can be computed as:

$$\\ {min}_{d , 0 \leq θ < 2 π} \{ {\sum }_{i {}_{} ∈ {}_{} 𝒥} {[ \sqrt{{( {x}_{i} - x )}^{2} + {( {y}_{i} - y )}^{2}} - \sqrt{{( {x}_{i} - x - d cos θ )}^{2} + {( {y}_{i} - y - d sin θ )}^{2}} - {}_{} ( {t}_{n} ) ]}^{2} \}$$

where, for d, a search range of [0,0.02] meters is used. Note that the (x, y) that minimizes this objective will be the estimate of (x(t₁), y(t₁)) in one of the triangulation methods described herein. Results of the simulation show that triangulation-based localization that only uses carrier-phase information without the absolute range values is feasible.

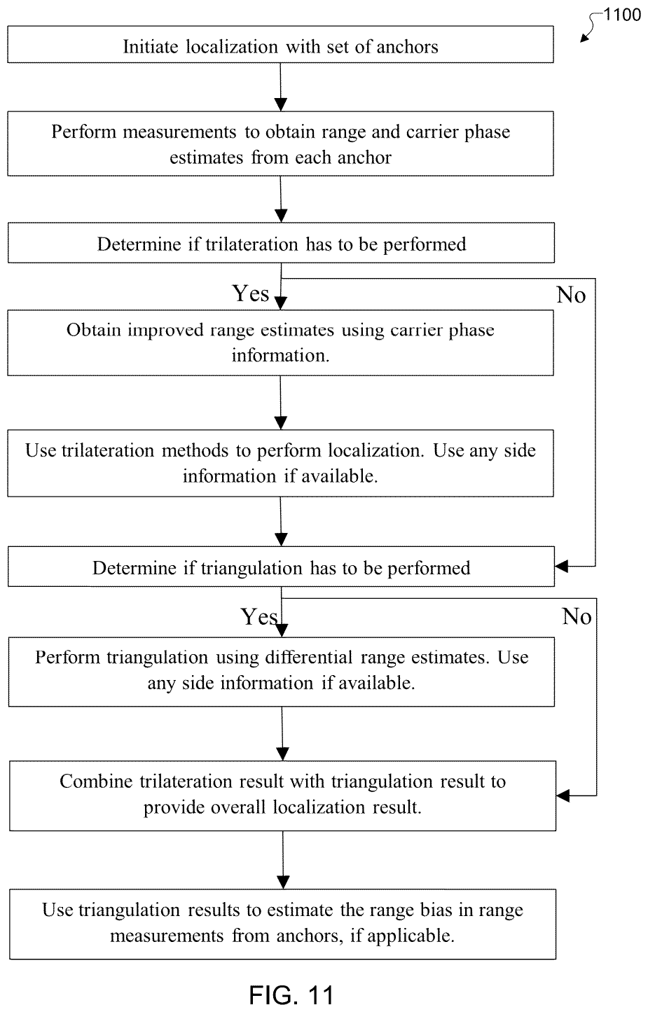

FIG. 11 illustrates a flow diagram showing an example procedure 1100 for improved localization using carrier phase information, according to embodiments of the present disclosure. As shown in FIG. 11, the procedure 1100 can be performed at a target device, such as the target device 501, for improving the localization performance. Although the procedure 1100 is depicted for a target device, it is applicable for any entity that is responsible for performing the localization of the target (including an anchor or another related device).

In some embodiments, rather than split the localization separately into trilateration and triangulation, a one-shot joint estimation may be performed using all the available information, including the range estimates [symbol] (tₙ) and carrier-phase based differential range estimates [symbol] (tₙ). In one example, such a joint estimation may be performed as:

$$\\ \hat{x} ( {t}_{1} ) , \hat{y} ( {t}_{1} ) , \hat{x} ( {t}_{2} ) , \hat{y} ( {t}_{2} ) , … , \hat{x} ( {t}_{N} ) , \hat{y} ( {t}_{N} ) = {arg min}_{{\overline{x}}_{1} , {\overline{y}}_{1} … {\overline{x}}_{N} , {\overline{y}}_{N}} \{ {\sum }_{n = 1}^{N} {μ}_{1} [ {\sum }_{i {}_{} ∈ {}_{} 𝒥} {[ {}_{} ( {t}_{n} ) - {B}_{i} - {B}_{0} - {}_{} ( {\overline{x}}_{n} , {\overline{y}}_{n} , i ) ]}^{2} ] + {\sum }_{n = 2}^{N} {μ}_{2} [ {\sum }_{i {}_{} ∈ {}_{} 𝒥} {[ {}_{} ( {t}_{n} ) - ρ ( {\overline{x}}_{n} , {\overline{y}}_{n} , i ) + ( {\overline{x}}_{n - 1} , {\overline{y}}_{n - 1} , i ) ]}^{2} ] \} ,$$

where μ₁, μ₂ are weighting coefficients, and the function [symbol] (x̅, y̅, i) [symbol] \sqrt{(x̅−xᵢ)²+(y̅−yᵢ)²} is defined for any i∈ [symbol] .

In other embodiments, to reduce the complexity of the joint search, an iterative process may be followed where the location estimate \hat{x}(tₙ), ŷ(tₙ) is sequentially estimated for each n, while assuming all prior estimates \hat{x}(tₘ), ŷ(tₘ) for 1≤m<n are accurate. This can be depicted as:

$$\\ \hat{x} ( {t}_{n} ) , \hat{y} ( {t}_{n} ) = {arg min}_{x , y} \{ {μ}_{1} [ {\sum }_{i {}_{} ∈ {}_{} 𝒥} {[ {}_{} ( {t}_{n} ) - {B}_{i} - {B}_{0} - {}_{} ( x , y , i ) ]}^{2} ] + {μ}_{2} [ {\sum }_{i {}_{} ∈ {}_{} 𝒥} {[ {}_{} ( {t}_{n} ) - ρ ( x , y , i ) + ( {\hat{x}}_{n - 1} , {\hat{y}}_{n - 1} , i ) ]}^{2} ] \} .$$

After the sequential estimation, an optional backward pass can also be included to estimate sequentially from t_{N} down to t₁ as:

$$\\ \hat{x} ( {t}_{n} ) , \hat{y} ( {t}_{n} ) = {arg min}_{x , y} \{ {μ}_{1} [ {\sum }_{i {}_{} ∈ {}_{} 𝒥} {[ {}_{} ( {t}_{n} ) - {B}_{i} - {B}_{0} - {}_{} ( x , y , i ) ]}^{2} ] + {μ}_{2} [ {\sum }_{i {}_{} ∈ {}_{} 𝒥} {[ {}_{} ( {t}_{n + 1} ) - ( {\hat{x}}_{n + 1} , {\hat{y}}_{n + 1} , i ) - ρ ( x , y , i ) ]}^{2} ] \} .$$

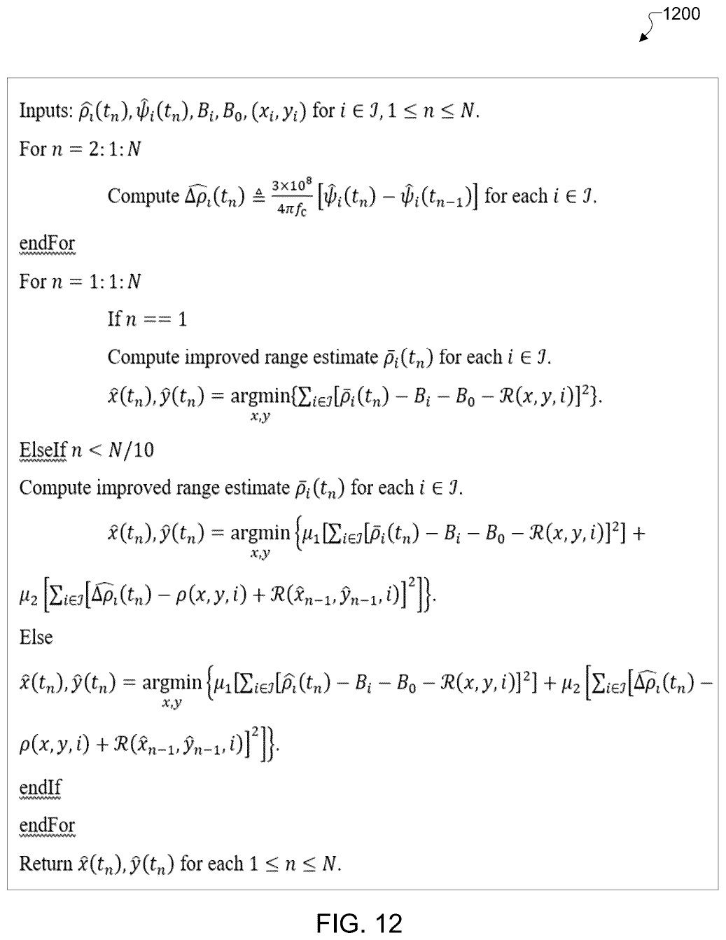

For illustration, FIG. 12 illustrates an example summary algorithm 1200 showing the sequential estimation according to embodiments of the present disclosure.

As described herein, the disclosed embodiments improve trilateration-based localization and also enable triangulation-based localization with single antennas. The disclosed embodiments are applicable to both Wi-Fi-based and Bluetooth-based architectures (with minor changes). Thus, the disclosed embodiments can be used to improve the performance of localization in most smart consumer devices.

The disclosed embodiments provide multiple advantageous benefits over existing techniques, including much higher accuracy and lower requirements on bandwidth and number of antennas. In addition, the disclosed embodiments can be used for a wide variety of use cases, including the following:
Enabling localization of a single antenna device (e.g., smart watch, robot vacuum) by performing frame exchanges with a single anchor such as an AP.
Enable arm gesture recognition by performing fine localization of the user's arm (with a smart watch on it) with respect to an anchor.
Behind-the-wall object detection by using the channel state information collected from a mobile receiver for a transmitted signal transmitted from a fixed transmitter. The mobile receiver may move around and generate a large coherent virtual antenna array using the carrier phase information that enables the object detection by enhancing the signal dimension spatially.

In addition, the carrier phase information can be used for direction finding, instead of localization, i.e., identifying the angle of the line-of-sight path from the target to the anchor or vice versa. So, the disclosed embodiments can be used in several direction-finding use cases, such as guiding a user of a first device (e.g., a smart watch or wireless earbuds) towards the location of a second device (e.g., a phone) by providing the direction information to move in. Even with single antenna devices, such directional information can be obtained when either of the first or second device is mobile, by creating a virtual antenna array and exploiting the sum-carrier phase information. For example, a user wearing a smart watch may move his hand to enable creating the virtual antenna array for direction finding. In another example, the first device can be a robot vacuum or a swiveling home hub that can move or rotate to create the virtual antenna array to find the direction towards the second device.

Although FIGS. 5 through 12 illustrate example techniques for enhanced localization by exploiting carrier phase information and related details, various changes may be made to FIGS. 5 through 12. For example, various components in FIGS. 5 through 12 could be combined, further subdivided, or omitted and additional components could be added according to particular needs. In addition, while shown as a series of steps, various operations in FIGS. 5 through 12 could overlap, occur in parallel, occur in a different order, or occur any number of times. In another example, steps may be omitted or replaced by other steps.

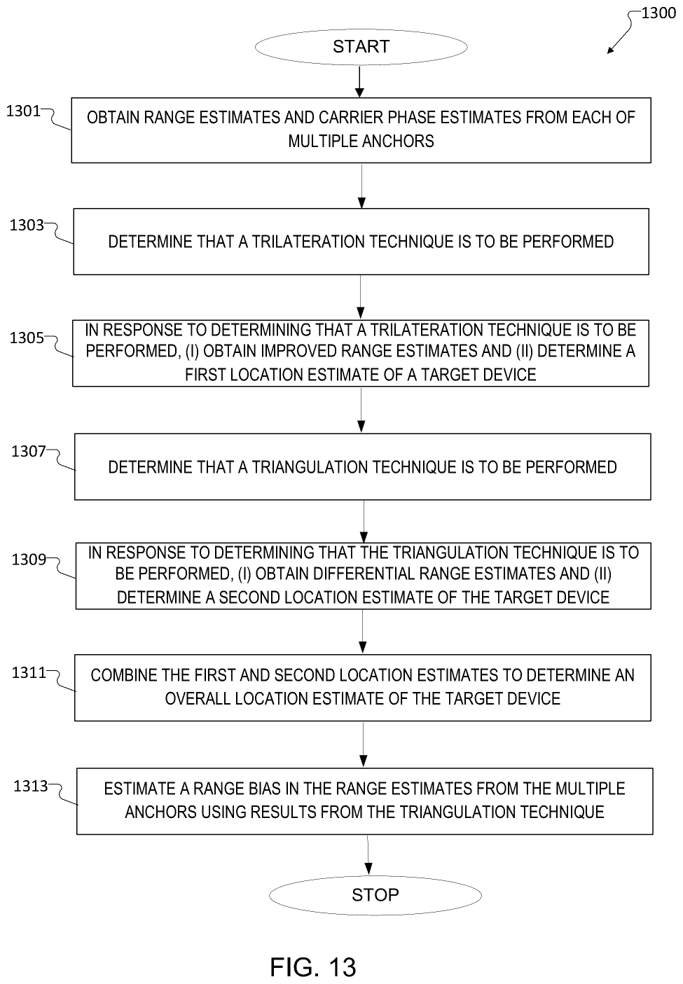

FIG. 13 illustrates a flow chart of a method 1300 for enhanced localization by exploiting carrier phase information according to various embodiments of the present disclosure, as may be performed by one or more components of the wireless network 100 (e.g., the AP 101 or the STA 111), which may represent a target device 501, an anchor 502, or a separate localization device. The embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins at step 1301. At step 1301, a device obtains range estimates and carrier phase estimates from each of multiple anchors. This could include, for example, the STA 111 obtaining range estimates and carrier phase estimates from each of the anchors 502. In some embodiments, the carrier phase estimates from one of the multiple anchors is used to find a direction of a target device with respect to the one anchor.

At step 1303, the device determines that a trilateration technique is to be performed. The determination can be based on at least one of: an amount of error in the range estimates, a clock accuracy, and an amount of variation in the carrier phase estimates across multiple time samples. This could include, for example, the STA 111 determining that a trilateration technique is to be performed.

At step 1305, in response to determining that the trilateration technique is to be performed, the device obtains improved range estimates using the carrier phase estimates, and determines a first location estimate of the target device using the trilateration technique and the improved range estimates. This could include, for example, the STA 111 obtaining improved range estimates using the carrier phase estimates, and determining a first location estimate of the target device 501 using the trilateration technique and the improved range estimates. In some embodiments, the trilateration technique uses at least one of: locations of the multiple anchors; the improved range estimates from the multiple anchors for a plurality of time steps; prior knowledge about range bias or target device velocity; and hidden variables to account for unknown components of the range bias or the target device velocity. In some embodiments, obtaining the improved range estimates using the carrier phase estimates includes determining the differential range estimates based on the carrier phase estimates, and weighted averaging the range estimates and the differential range estimates across a time domain to obtain the improved range estimates.

At step 1307, the device determines that a triangulation technique is to be performed. The determination can be based on at least one of: a variation of a sum-carrier phase over a time period being greater a predetermined threshold, a desired accuracy of localization being above a first threshold, and an available computation power for localization being above a second threshold. This could include, for example, the STA 111 determining that a triangulation technique is to be performed.

At step 1309, in response to determining that the triangulation technique is to be performed, the device obtains differential range estimates using the carrier phase estimates, and determines a second location estimate of the target device using the triangulation technique and the differential range estimates. This could include, for example, the STA 111 obtaining differential range estimates using the carrier phase estimates, and determining a second location estimate of the target device 501 using the triangulation technique and the differential range estimates. In some embodiments, the triangulation technique uses at least one of: locations of the multiple anchors; the differential range estimates for a plurality of time steps; prior knowledge about an orientation or a speed of the target device; and hidden variables to account for unknown components of the orientation or the speed of the target device.

At step 1311, the device combines the first location estimate and the second location estimate to determine an overall location estimate of the target device. This could include, for example, the STA 111 combining the first location estimate and the second location estimate to determine an overall location estimate of the target device 501. In some embodiments, combining the first location estimate and the second location estimate to determine the overall location estimate of the target device includes weighted combining the first location estimate and the second location estimate using preselected weights, or computing a solution to a weighted combining of objective functions of the trilateration technique and the triangulation technique. In some embodiments, the preselected weights are selected based on at least one of: available bandwidth, operating signal to noise ratio (SNR), estimation accuracy, and computation complexity.

At step 1313, the device estimates a range bias in the range estimates from the multiple anchors using results from the triangulation technique. This could include, for example, the STA 111 estimating a range bias in the range estimates from the multiple anchors 502 using results from the triangulation technique.

Although FIG. 13 illustrates one example of a method 1300 for enhanced localization by exploiting carrier phase information, various changes may be made to FIG. 13. For example, while shown as a series of steps, various steps in FIG. 13 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining range estimates and carrier phase estimates from each of multiple anchors;
in response to determining that a trilateration technique is to be performed, (i) obtaining improved range estimates using the carrier phase estimates and (ii) determining a first location estimate of a target device using the trilateration technique and the improved range estimates;
in response to determining that a triangulation technique is to be performed, (i) obtaining differential range estimates using the carrier phase estimates and (ii) determining a second location estimate of the target device using the triangulation technique and the differential range estimates; and
combining the first location estimate and the second location estimate to determine an overall location estimate of the target device.

2. The method of claim 1, further comprising:
determining that the trilateration technique is to be performed based on at least one of: an amount of error in the range estimates, a clock accuracy, or an amount of variation in the carrier phase estimates across multiple time samples.

3. The method of claim 1, wherein obtaining the improved range estimates using the carrier phase estimates comprises:
determining the differential range estimates based on the carrier phase estimates; and
weighted averaging the range estimates and the differential range estimates across a time domain to obtain the improved range estimates.

4. The method of claim 1, wherein the trilateration technique uses at least one of:
locations of the multiple anchors;
the improved range estimates from the multiple anchors for a plurality of time steps;
prior knowledge about range bias or target device velocity; or
hidden variables to account for unknown components of the range bias or the target device velocity.

5. The method of claim 1, further comprising:
determining that the triangulation technique is to be performed based on at least one of:
a variation of a sum-carrier phase over a time period being greater a predetermined threshold;
a desired accuracy of localization being above a first threshold; or
an available computation power for localization being above a second threshold.

6. The method of claim 1, wherein the triangulation technique uses at least one of:
locations of the multiple anchors;
the differential range estimates for a plurality of time steps;
prior knowledge about an orientation or a speed of the target device; or
hidden variables to account for unknown components of the orientation or the speed of the target device.

7. The method of claim 1, wherein combining the first location estimate and the second location estimate to determine the overall location estimate of the target device comprises one of:
weighted combining the first location estimate and the second location estimate using preselected weights; or
computing a solution to a weighted combining of objective functions of the trilateration technique and the triangulation technique.

8. The method of claim 7, wherein the preselected weights are selected based on at least one of: available bandwidth, operating signal to noise ratio (SNR), estimation accuracy, or computation complexity.

9. The method of claim 1, further comprising:
estimating a range bias in the range estimates from the multiple anchors using results from the triangulation technique.

10. The method of claim 1, wherein the carrier phase estimates from one of the multiple anchors is used to find a direction of the target device with respect to the one anchor.

11. A device comprising:
a transceiver; and
a processor operably connected to the transceiver, the processor configured to:
obtain range estimates and carrier phase estimates from each of multiple anchors;
in response to determining that a trilateration technique is to be performed, (i) obtain improved range estimates using the carrier phase estimates and (ii) determine a first location estimate of a target device using the trilateration technique and the improved range estimates;
in response to determining that a triangulation technique is to be performed, (i) obtain differential range estimates using the carrier phase estimates and (ii) determine a second location estimate of the target device using the triangulation technique and the differential range estimates; and
combine the first location estimate and the second location estimate to determine an overall location estimate of the target device.

12. The device of claim 11, wherein the processor is further configured to:
determine that the trilateration technique is to be performed based on at least one of: an amount of error in the range estimates, a clock accuracy, or an amount of variation in the carrier phase estimates across multiple time samples.

13. The device of claim 11, wherein to obtain the improved range estimates using the carrier phase estimates, the processor is configured to:
determine the differential range estimates based on the carrier phase estimates; and
weighted average the range estimates and the differential range estimates across a time domain to obtain the improved range estimates.

14. The device of claim 11, wherein the trilateration technique uses at least one of:
locations of the multiple anchors;
the improved range estimates from the multiple anchors for a plurality of time steps;
prior knowledge about range bias or target device velocity; or
hidden variables to account for unknown components of the range bias or the target device velocity.

15. The device of claim 11, wherein the processor is further configured to:
determine that the triangulation technique is to be performed based on at least one of:
a variation of a sum-carrier phase over a time period being greater a predetermined threshold;
a desired accuracy of localization being above a first threshold; or
an available computation power for localization being above a second threshold.

16. The device of claim 11, wherein the triangulation technique uses at least one of:
locations of the multiple anchors;
the differential range estimates for a plurality of time steps;
prior knowledge about an orientation or a speed of the target device; or
hidden variables to account for unknown components of the orientation or the speed of the target device.

17. The device of claim 11, wherein to combine the first location estimate and the second location estimate to determine the overall location estimate of the target device, the processor is configured to perform one of:
weighted combine the first location estimate and the second location estimate using preselected weights; or
compute a solution to a weighted combining of objective functions of the trilateration technique and the triangulation technique.

18. The device of claim 17, wherein the preselected weights are selected based on at least one of: available bandwidth, operating signal to noise ratio (SNR), estimation accuracy, or computation complexity.

19. The device of claim 11, wherein the processor is further configured to:
estimate a range bias in the range estimates from the multiple anchors using results from the triangulation technique.

20. A non-transitory computer readable medium comprising program code that, when executed by a processor of a device, causes the device to:
obtain range estimates and carrier phase estimates from each of multiple anchors;
in response to determining that a trilateration technique is to be performed, (i) obtain improved range estimates using the carrier phase estimates and (ii) determine a first location estimate of a target device using the trilateration technique and the improved range estimates;
in response to determining that a triangulation technique is to be performed, (i) obtain differential range estimates using the carrier phase estimates and (ii) determine a second location estimate of the target device using the triangulation technique and the differential range estimates; and
combine the first location estimate and the second location estimate to determine an overall location estimate of the target device.
